(19) United States
(12) Patent Application Publication
(10) Pub. No.: US 2013/0258298 A1
(43) Pub. Date: Oct. 3, 2013

(54) LED image projection apparatus

(71) Applicant: Khok Hing-wai, Tsuen Wan (CN)

(72) Inventor: Khok Hing-wai, Tsuen Wan (CN)

(73) Assignee: Waitrony Optoelectronics Limited, Tsuen Wan (CN)

(21) Appl. No.: 13/506,203

(22) Filed: Apr. 3, 2012

(51) Int. Cl. G03B 21/26

(52) U.S. Cl. 353/94

(57) ABSTRACT

A light emitting diode image projection apparatus, comprising a light emitting diode as a light source, a transparent optical grade LED body, having a pattern layer and having an exterior epoxy layer formed about said LED body. The distal end of the LED body is a substantially flat-curved surface (while not being totally flat), while the transparent encapsulating epoxy layer is a sharp-curved, convex surface. This configuration of effective lens structures provides a double encapsulation such that structurally, the effects of the light reflection and the image projection are the same as those of the LED with external plastic outside shells, but the instant invention greatly reduces cost over the former.

### FIELD OF INVENTION

The present disclosure relates generally to light emitting diodes (LED's) and, more particularly, to an LED image projection apparatus.

### BACKGROUND

Light-emitting diodes (LED) may have a basic structure comprising a few components such as a light-emitting wafer, some sort of structural housing, bonding agent (such as glue), and conductive coupling wires. Bonding agents may be used as a silver epoxy or silicone epoxy, and one or more light-emitting wafer may be bonded together and coupled via conductive wires. The epoxies may form a head of some sort of resin, and may take on different encapsulation shapes, which generate different illumination appearances and different spotlighting effects. For example, a relatively flat-curved head makes the emitted light scattered, and while relatively sharp-curved head may make the emitted light more centralized.

In some conventional LED image projection structures, a plastic outer shell is installed on the exterior of the LED, and the projecting image is imprinted on the outer shell. The outer most portion of the outer shell may further comprise a molded lens for focusing, and thus, an image can be projected onto any suitable projection surface (such as a wall, etc.).

FIG. 1 illustrates a simple LED structure 50 known in the prior art. The LED structure 50 shows a basic structure of an LED comprising a light-emitting wafer 1, a lead frame 2, bonding agent 3 and a coupling wire 4. The lead frame 2 is coated with the bonding agent 3. One or more wafer 1 are affixed via the bonding agent 3, and the coupling wire 4 is connected to the lead frame 2 to provide an electrical current flow. An epoxy resin 5, or other insulation glue, is used for encapsulating the lead frame 2 within the circuit.

FIG. 2 illustrates the prior art configuration of a LED projection structure 55. In this conventional LED image projection structure 55, a plastic shell 6 is installed on the exterior of the LED. An image 15 is printed on the plastic shell 6; and the front portion of the plastic shell 6 is equipped or molded with a lens 7 for focusing and thus projecting an image on a projection panel, such as wall, etc.

This conventional structure is lacking in that although the plastic shell installed on the exterior of the LED may project images, the manufacturing costs of such a configuration are high.

Therefore, other prior art teaches of directly printing the images on the LED, but this structure has its own defects. For example, if the image is printed on a relatively flat or a flat-curved LED, the projected image is clear, but the light emitted is scattered; and when the intensity of the light projected on the panel is dark, then the image becomes dim and unclear. If the image is clear, the projection distance is very short, which means the distance between the LED and the projection panel is very short, which is of no projection significance. If the image is printed on an LED with a relatively sharp-curved LED, the light projected on the panel is relatively intense and centralized, but the image is positioned on a round surface which has a lens effect, therefore, the light reflects, and then the image is distorted.

Accordingly, there is a need to overcome such optical deficiencies described above by a simplistic design that can be easily reproduced with readily obtainable materials, thus reducing manufacturing costs.

### SUMMARY OF THE INVENTION

The present invention addresses the above-described deficiencies and others. Specifically, the present invention provides a LED image projection apparatus that is novel, and easy and inexpensive to manufacture. To solve the mentioned optical and technical problems, the invention provides an LED image projection structure having less parts, and a novel housing structure adapted and configured to encapsulate the LED as well as serve as a lens.

In accordance with an aspect of the present disclosure, there is disclosed a LED apparatus which will be durable and efficient in use, and simple to manufacture, and placed upon the market at a reasonable cost.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

### BRIEF DESCRIPTION OF THE DRAWINGS

Embodiments of the present disclosure are described herein with reference to the drawings, in which:

FIG. 1 is a diagram of a prior art LED structure;

FIG. 2 is a diagram of a configuration of a prior art LED image projection structure;

FIG. 3 is a cross sectional schematic diagram of components of a LED image projection apparatus, according to certain embodiments of the present disclosure; and

FIG. 4 is a cross sectional schematic diagram of the LED image projection apparatus according to certain embodiments of the present disclosure.

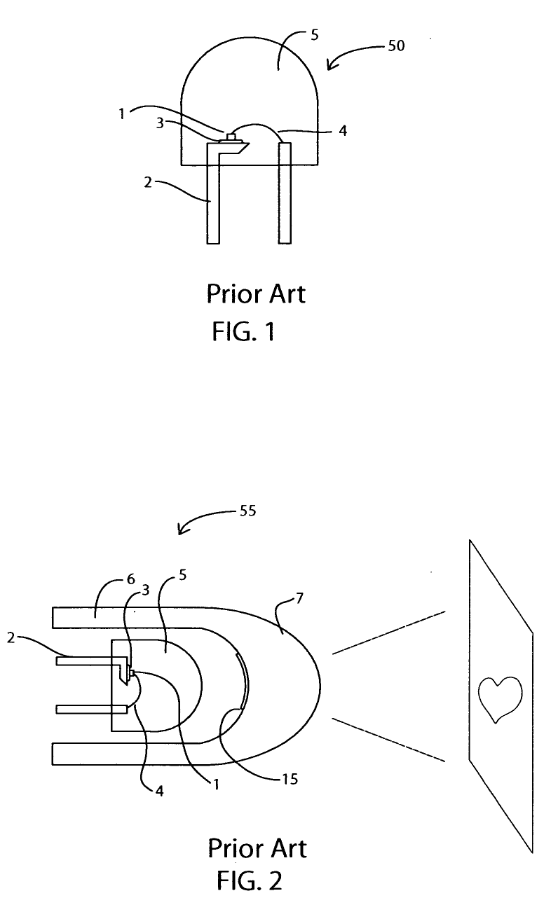

The novel features which are characteristic of the invention, as to organization and method of use, together with further objects and advantages thereof, will be better understood from the following disclosure considered in connection with the accompanying drawings in which one or more preferred embodiments of the invention are illustrated by way of example. It is to be expressly understood, however, that the drawings are for the purpose of illustration and description only and are not intended as a definition of the limits of the invention.

As used herein, the term “comprises” refers to a part or parts of a whole, but does not exclude other parts. That is, the term “comprises” is open language that requires the presence of the recited element or structure or its equivalent, but does not exclude the presence of other elements or structures. The term “comprises” has the same meaning and is interchangeable with the terms “includes” and “has”. The term set has the meaning of one or more of said element. Furthermore, any use of the term “or” as used herein is generally intended to mean “and/or” unless otherwise indicated. Combinations of components or steps will also be considered as being noted, where terminology is foreseen as rendering the ability to separate or combine is unclear.

### DETAILED DESCRIPTION

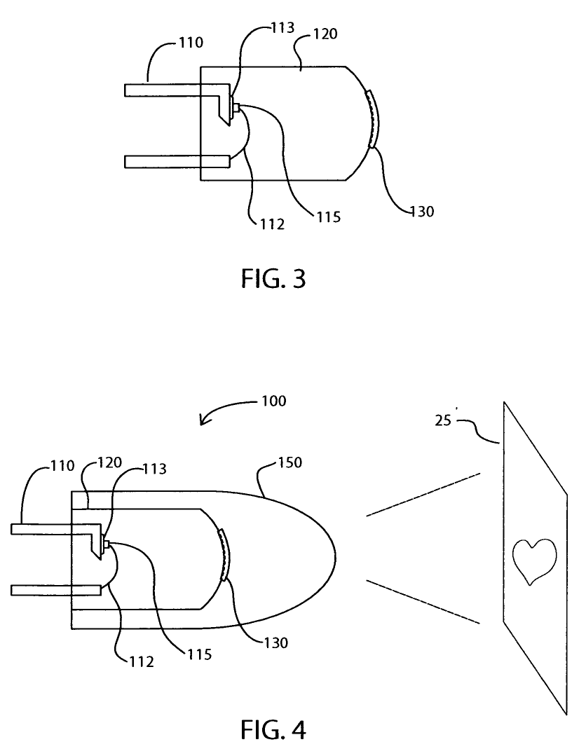

As shown in FIGS. 3 and 4, an LED image projection apparatus 100 may comprise a LED body 120 comprising a light emitting diode (LED) wafer 115 as a light source, a set of electrically coupling conductive lead frames 110, a conductive coupling wire 112, and a pattern layer 130 imprinted or impinged upon on the distal portion of the LED body 120. The wafer 115 is bonded to at least one lead frame 110 by a bonding agent 113. The pattern layer 130 may comprise an image or indicia which may include visible pictures, characters, numbers, symbols, marks, schematic views, signs, photos and drawings. The conductive coupling wire 112 may be comprised of any suitable electrically conductive material known in the art such as gold, aluminum, copper, silver, or other alloy and is at least partially contained within said LED body 120. The LED image projection apparatus 100 further comprises a transparent epoxy layer 150 which is fully encapsulated or formed about the distal portion of the LED body 120, and which is exterior to the pattern layer 130. The pattern layer 130 may be formed integral to the distal end portion of the LED body 120. The epoxy layer 150 may be any suitable epoxy resin.

According to the structure of the invention, the distal end portion of the LED body 120 containing the pattern layer 130 is a substantially flat-curved surface (i.e. substantially planar with minimal convexity, or minimally plano-convex) while the transparent epoxy layer 150 is operatively connected adjacent to said LED body 120 and exterior to said pattern layer 130, and has a convex shape.

The invention employs double encapsulation technology with the adjacent structures of the LED body 120 and the transparent epoxy layer 150 formed in the manner that they are such that a relatively flat-curved surface of the distal end of the LED body 120 is first encapsulated on the LED to then appropriately imprint the image of the pattern layer 130, and then on through the focal region of the transparent epoxy layer 150, which is of a relatively sharp-curved convex surface, and is secondarily encapsulated to achieve a lens effect to properly project an image 25. The distal end surface of the LED body 120, however, cannot be completely flat (planar) because a totally planar surface makes the light exiting the periphery of the epoxy layer 150 scattered, which causes a ring of intensive light and thus adversely affects the optical outcome of the projected image. The epoxy layer 150 is adapted and configured such that it fully encapsulates the LED body 120.

It is to be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform or assist with any of the methods and procedures for manufacturing the apparatus described herein.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used and/or to the particular embodiment disclosed as the best mode contemplated for carrying out this invention, but that the invention will include any and all embodiments and equivalents falling within the scope of the instant disclosure.

For example, the LED wafer 115 may be bonded by a single conductive wire 112, or multiple wires. A product may have one or several wafer 115, depending on the features needed. The set of lead frames 110 may have two or more supporting legs, or none at all (surface mounted device). Moreover, a pigment, a diffusing agent or fluorescent phosphor powder may be added into the LED body 120 or the epoxy layer 150. The pigment makes the LED body 120 or the epoxy layer 150 colorful; the diffusing agent allows the entirety of the LED body 120 or the epoxy layer 150 to emit light; and the fluorescent phosphor powder is capable of changing the wavelength and therefore changing the color of the emitted light. The light-emitting intensity and the color of the emitted light is determined by the wafer, however the wafer does not make any color, it is the fluorescent phosphor powder that is added that can change and modify the color.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

What is claimed is:

1. A light emitting diode image projection apparatus, comprising:
at least one light emitting diode (LED), for emitting light
said light emitting diode coupled to a set of conductive lead frames by a set of conductive wires, and
a LED housing body fully encapsulating said light emitting diode;
said LED housing body having a patterned layer having at least one image, and adapted and configured on a distal end thereof for optical coupling with said light emitting diode;
a transparent epoxy layer fully encapsulating said LED body, and having a convex shape, wherein said convex shape is adapted for optically coupling said emitted light from said light emitting diode and said at least one image from said patterned layer to project an image.

2. A light emitting diode image projection apparatus of claim 1 wherein:
said LED housing body has a distal end adapted and configured to have a substantially, but not totally flat, planar surface adjacent said patterned layer.

3. A light emitting diode image projection apparatus of claim 2 wherein:
said patterned layer may include visible pictures, characters, numbers, symbols, marks, schematic views, signs, photos and drawings.

4. A light emitting diode image projection apparatus of claim 3 wherein:
said epoxy layer is comprised of an optical epoxy resin.

5. A light emitting diode image projection apparatus of claim 4 wherein:
said LED body is comprised of a transparent epoxy resin.

6. A light emitting diode image projection apparatus of claim 5 wherein:
said LED body comprises a plurality of light emitting diodes.

7. A light emitting diode image projection apparatus of claim 6 wherein:
said set of conductive lead frames are at least partially contained within said LED body.

8. A light emitting diode image projection apparatus of claim 2 wherein:
said encapsulating epoxy layer is exterior to said pattern layer; and said pattern layer is on distal end of said LED body.

9. A light emitting diode image projection apparatus of claim 8 wherein:
said pattern layer is formed integrally with said LED body.

10. A light emitting diode image projection apparatus of claim 9 wherein:
wherein said LED body is adapted and configured to be substantially plano-convex.
